(19) United States
(12) Patent Application Publication
(10) Pub. No.: US 2018/0194386 A1
(43) Pub. Date: Jul. 12, 2018

(54) CHARIOT FOR HORSE AND DRIVER TRAINING IN HORSERACING

(71) Applicant: Sam Stathis, New York, NY (US)

(72) Inventor: Sam Stathis, New York, NY (US)

(21) Appl. No.: 15/913,911

(22) Filed: Mar. 6, 2018

Related U.S. Application Data
(60) Provisional application No. 62/536,461, filed on Jul. 25, 2017.

(51) Int. Cl. B62C 1/08; G09B 9/052

(52) U.S. Cl. CPC B62C 1/08; G09B 9/05; G09B 9/052

(57) ABSTRACT

The Present Invention is a chariot that resembles and functions like a training jog cart or sulky in harness racing. The function of the chariot is to train horses and drivers. The chariot receives telemetry from both the horse and the driver, and processes the data with an onboard computer system. The chariot comprises a display (or dashboard) and audio processor to provide the driver and other observers with information. It can be used to train or monitor drivers, Olympic athletes, equine athletes, or animals other than horses, and may be equipped with technologies often used in NASCAR or Formula One vehicles. The chariot may also be used interactively in immersive racing simulators and fantasy games.

### CROSS REFERENCE TO RELATED APPLICATIONS

This Present Application is the nonprovisional counterpart of U.S. Provisional Patent Application Ser. No. 62/536,461 filed on Jul. 25, 2017. This Present Application claims priority to and the benefit of said provisional patent application, which is incorporated by reference herein in its entirety.

### CROSS REFERENCE TO RELATED APPLICATIONS

This Present Application is the nonprovisional counterpart of U.S. Provisional Patent Application Ser. No. 62/536,461 filed on Jul. 25, 2017. This Present Application claims priority to and the benefit of said provisional patent application, which is incorporated by reference herein in its entirety.

### BACKGROUND OF THE INVENTION

Horseracing enjoys popularity in the United States and abroad. There are three principal types of horseracing—flat racing, jump racing, and harness racing. Flat racing and jump racing employs jockeys riding on the backs of horses using saddles. In flat racing, a horse is made to gallop at full speed around a track or strip. Jump racing is also called steeplechase racing. Here, a horse is made to jump over hurtles on a racetrack. A harness race is also called a pacing or trotting race depending upon the gate of the harnessed horse. The driver sits in a lightweight two-wheel cart called a sulky, and the horse trots around the track. A sulky is a type of chariot.

Present methods and equipment used to train and race horses are antiquated. This creates many problems. The most severe is the widespread injuries to horses and drivers. As a result, millions of dollars per year are lost and wasted on non-holistic sports medicine, such as dangerous injections, drugs, and quick fixes, with much less attention given to prevention and proper training. Injuries are so prevalent that there is an overabundance of horses being forced to retire at very early ages or euthanized to be sold for glue, pet products, or meat for human consumption.

Fifty years ago, harness racing was one of the fastest growing sports in America. Today, it is on the verge of extinction. This would devastate the already declining agricultural industry in the United States. The closing of farms, the decline of real estate values as well as supporting activities, such as transportation, hospitality, veterinary care, horse feed production, tack shops, etc., would have a rippling effect. The Present Invention has the ability to:
save the entire harness racing industry;
expand economic growth by advancing workforce development through education and simulation;
prevent many human injuries from accidents resulting from exposed conventional sulky wheels becoming entangled and drivers being catapulted from their seats, or being run over by another horse, which can be prevented or minimized;
spot doping and stop cheating; and
save thousands of horses per year from injury or slaughter.

It is desirable to train horses and drivers in chariots that are not listed in current United States Trotting Association specifications. For horse training, it would be desirable to add resistance to the wheels to retard the motion of the horse to prevent an accident. Conversely, the training chariot could provide thrust to increase the speed of the horse while decreasing the stress on the horse. An ideal training chariot would collect telemetry regarding the stresses and strains at various locations on the body of the horse, as well as biometric indicators of both the horse and driver.

Eventually horse races using chariots not currently approved by the U.S. Trotting Association could be organized. These chariots could display advertising on sponsorship vehicles.

Training of drivers could be accomplished where a horse is harnessed to the chariot. However, drivers could also be trained with simulators that use the chariot of the Present Invention. Finally, the chariot and simulator can form part of a fantasy game. The participant (or driver) would be seated in the chariot in front of a video screen, and an animated horse would be driven around a simulated track. The Wii or Xbox platform would be ideal for this application. The fantasy game could include provisions for wagering.

### BRIEF DESCRIPTION OF THE DRAWINGS

FIG. 1 is a side elevation of a training chariot illustrating the shafts in contact with a horse. Here, the contact point of the shafts is the horse's mid-back.

FIG. 2 is a side elevation of the training chariot of the Present Invention.

FIG. 3 is a rear isometric view of the training chariot of the Present Invention.

FIG. 4 is a side elevation of the training chariot of the Present Invention with the horse harnessed to the chariot. A driver is seated in the rear of the chariot behind the horse.

FIG. 5 is the drawing of FIG. 4 showing force transducers attached to various points on the horse and on the seat of the chariot.

FIG. 6 is the drawing of FIG. 4 showing biometric sensors attached to various points on the horse and the driver.

FIG. 7 is a photograph of a first embodiment of the chariot of the Present Invention.

FIG. 8 is a photograph of a second embodiment of the chariot of the Present Invention.

FIG. 9 is a photograph of a third embodiment of the chariot of the Present Invention.

FIG. 10 is a photograph of a fourth embodiment of the chariot of the Present Invention.

FIG. 11 is an isometric drawing of the chariot of the Present Invention used in a simulator or fantasy game.

### SUMMARY OF THE INVENTION

The Present Invention is a chariot that resembles and functions like a training jog cart or sulky in harness racing. The function of the chariot is to train horses and drivers. The chariot receives telemetry from both the horse and the driver, and processes the data with an onboard computer system. The chariot comprises a display (or dashboard) and audio processor to provide the driver and other observers with information. It can be used to train or monitor drivers, equine and Olympic athletes, and may be equipped with technologies often used in NASCAR or Formula One vehicles. The chariot may also be used interactively in immersive racing simulators and fantasy games. The simulators can also employ virtual reality and augmented reality techniques.

### DESCRIPTION OF THE INVENTION

The Chariot System of the Present Invention is meant to send and receive synchronized performance information from a horse drawn cart/sulky/chariot race or training team. The vehicle, the driver and the horse are outfitted with a plurality or sensors that allow for collection of performance information data. The system is also outfitted with a computing/processing and data logging electronics package, that includes the ability to accept and store, process and display the data from a multitude of different data sources. The electronics package is also comprised of communications systems so that information collected by the system can be simultaneously stored locally and transmitted to computing/processing, display and broadcast platforms remotely located in real time. A plurality of these systems may also be networked together for use by more than one participant.

The “onboard systems” or electronics package are also comprised of display and broadcast devices that serve the purpose of communication of information collected locally (data, audio, video) or communication of information (data, audio, video) received from a remote location to the driver or participant in real time.

The purpose of the system is to monitor, track, analyze, and deliver information for both historic and or real time health performance analysis, performance adjustment of human and equine athletes and also for creation of simulations that test and predict probable performance as a means of providing safety, gaining a competitive advantage, and performing the functions of entertainment gaming systems. The system may also be used for gambling.

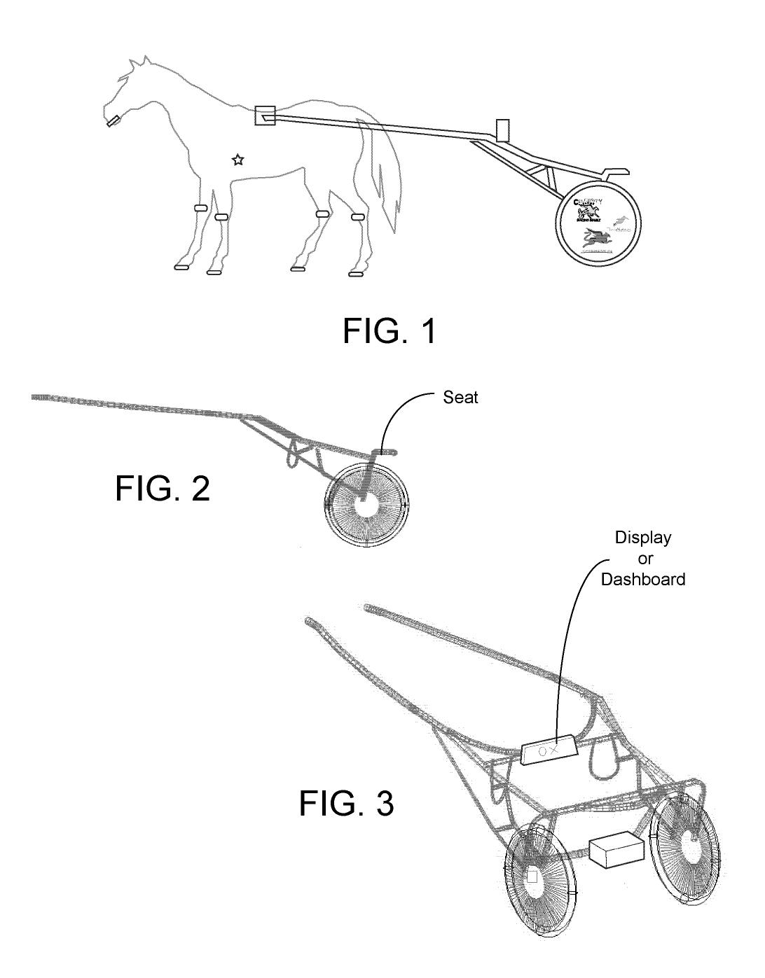

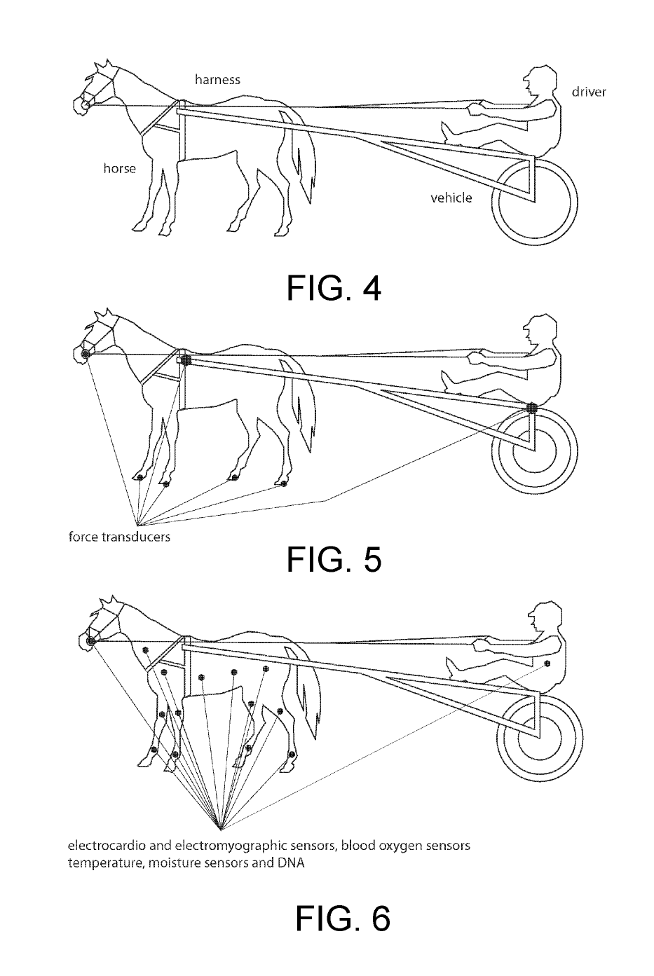

FIG. 1 illustrates the chariot of the Present Invention to which a horse is harnessed. Here, the shafts contact the horse on its mid-back. However, in FIGS. 4-6, the shafts contact the horse closer to its shoulders. FIGS. 2 and 3 show the chariot of the Present Invention.

### Sensors

Each horse drawn cart component is outfitted with a plurality of diverse sensors. The complete combination of sensors configured into one system is expandable with additional types of sensors, displays, broadcast and processing devices. The sensors that comprise the system actively measure and acquire information. Measurement data collected falls into several categories—including, but not limited to data from a horse (or team of horses pulling one chariot), the driver (or team of drivers sitting in or standing on one chariot), the sulky/cart/chariot, the harness, the environment, and synchronized data from all.

The sensors include but are not limited to (see FIG. 5) multi directional force transducers, gyroscopes, accelerometers, inertial measurement sensors, (see FIG. 6) electrocardio and electromyographic sensors, blood oxygen sensors, high resolution rotational speed and angular momentum sensors, temperature and moisture sensors, DNA identification, horse gate analysis, weather, track conditions, other environmental or venue specific conditions, and audio and video, etc.

Sensors are affixed to the Horse that may measure and collect for example vibration and loads, heart rate, temperature, blood oxygen, muscle energy/activity, perspiration, speed, gate, multi perspective synchronized video and audio, wind resistance/drag, distance traveled, etc.

Sensors are affixed to the Driver (or team of drivers) that may measure and collect for example heart rate, temperature, blood oxygen, muscle energy/activity, position, center of gravity, multi perspective synchronized video and audio, wind resistance/drag, distance traveled, calories burned, etc. The driver may also be provided with voice and/or visual communications equipment with a microphone and headphones/earpiece present. The signals may be communicated to or from drones hovering over each chariot.

Sensors are affixed to the Vehicle as well as the that may measure and collect for example vibration and loads, tensions, temperature, positions, center of gravity, multi perspective synchronized video and audio, wind resistance/drag, distance traveled, speed/velocity/ momentum, wheel rotation and orientation, weight, tracking, tire pressure, resistance, etc.

Cameras may be used to transmit video information. The cameras or displays may be affixed to the driver, horse, or vehicle, or even flying drones.

### Local Information Display

The synchronized composite information from all of the sensors selected to function for a particular trip is recorded and delivered visually and audibly to the driver via an earphone/headset, a digital display and or gauges (analog) affixed to the driver and or the vehicle.

### Remote Information Display

The synchronized composite information from all the sensors selected to function for a particular trip is recorded and delivered visually and audibly to the trainers and trainees, team members, or spectators at a remote location. The information is received, processed and displayed by a computer equipped with one or more digital displays, speakers and a communications system or it can be displayed in an analog format. It can be broadcast over wired or wireless communications, e.g., television, Internet, etc.

### Equipment

The vehicle takes various forms—a training vehicle, a racing vehicle, and an exotic chariot vehicle. The vehicle may be equipped with a generator in some form to produce and supply electrical energy to the onboard systems or for other systems remote from the vehicle this is done energy is produced while in transit.

The training vehicle is equipped with a redundant braking system that produces and supplies energy while at the same time furnishes a means of increasing or decreasing the resistance of the vehicles motion. The purpose of this feature set is to produce usable energy from the work that the Horse is doing and to furnish the ability to tune how hard the horse must work to pull the vehicle. This ultimately promotes the health and safety of the horse and driver by guarding against excessive or improper exercise related injuries or accidents.

The onboard systems includes a battery, power management, charge management, a central processing unit, input output connections, input/output devices including sensors, a keyboards, a mouse, a joystick, and triggers, and means of wireless and wired connectivity.

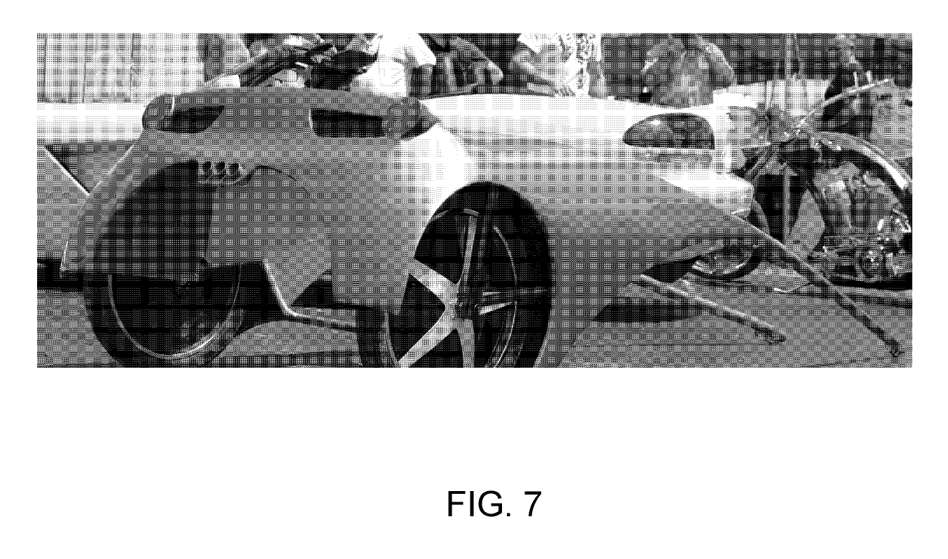

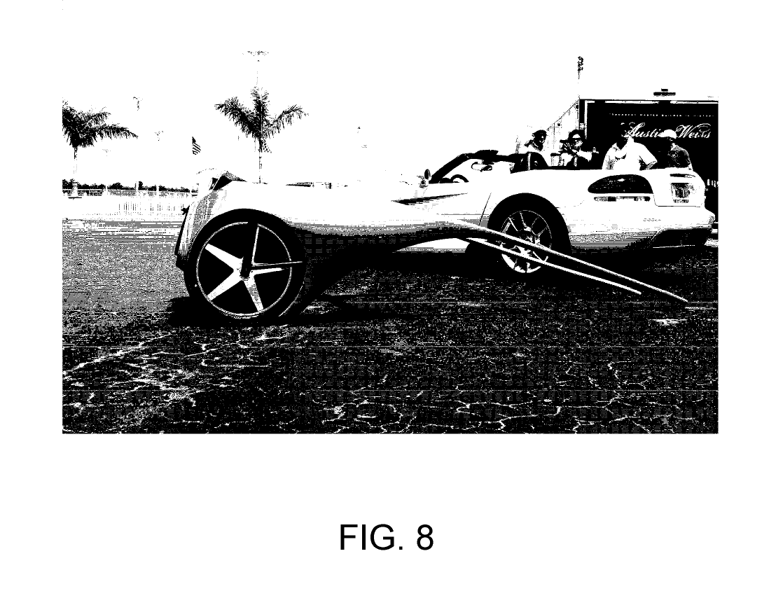

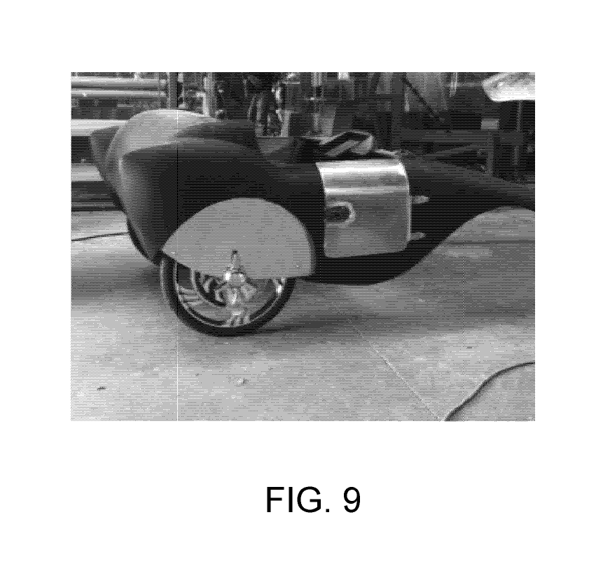

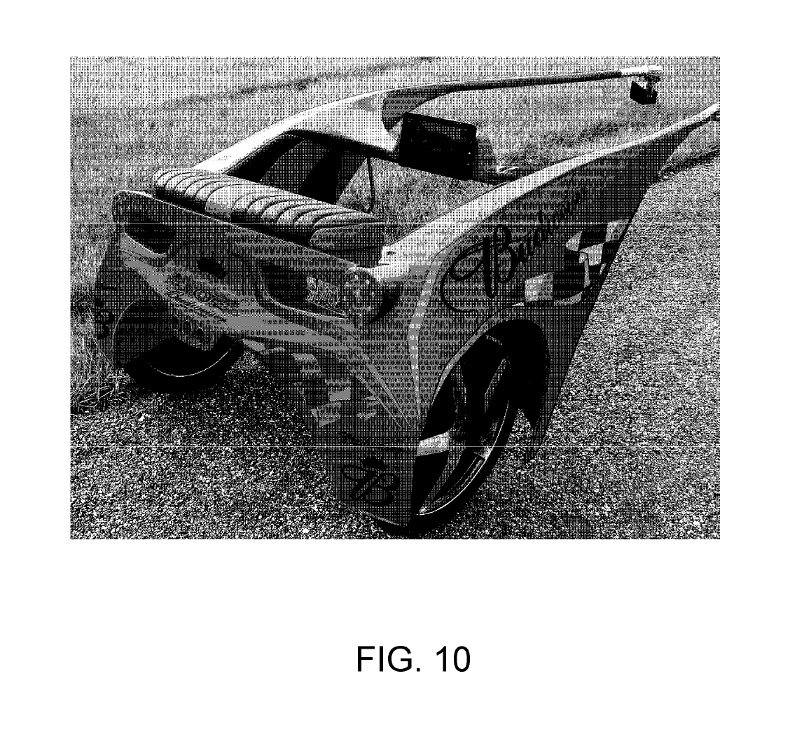

FIGS. 7-10 are photographs of various embodiments of the chariot of the Present Invention. In FIG. 10, the display is visible in the photograph.

### Simulations, Analysis and Gaming

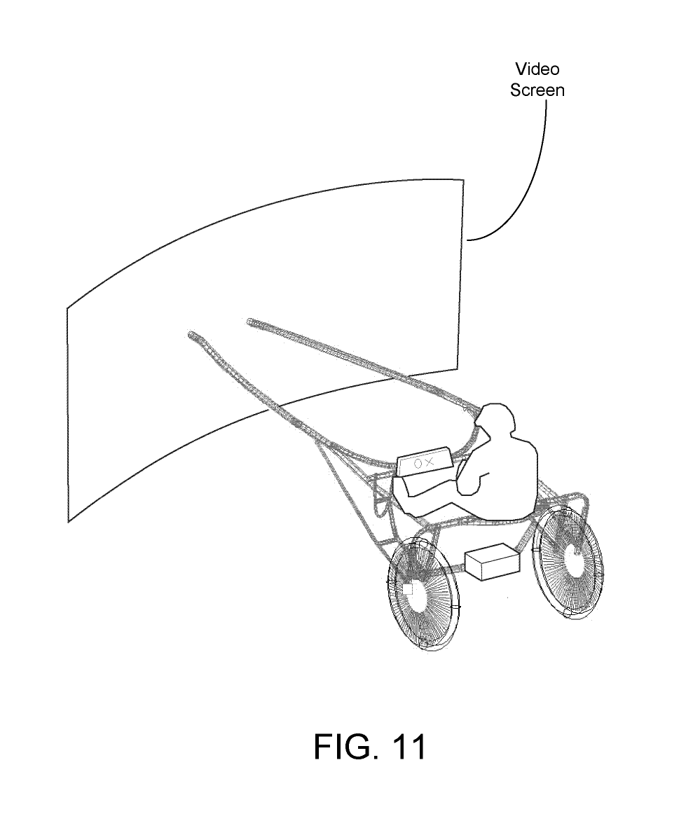

FIG. 11 illustrates the chariot of the Present Invention used in a racing simulator or fantasy game. In the drawing, a driver sits in the chariot or saddle behind a simulated view of the rear of a horse and racetrack displayed on a video screen. A Wii or Xbox platform is ideal for this application. The driver can perform whatever actions a driver would perform in an actual race, and the animated horse and chariot would react to those actions. The horse trots around a simulated racetrack.

Analysis of the synchronized or individual data sets may take place at either the remote location or onboard the vehicle while in transit. The data generated by the system will be utilized to inform the function of horse drawn racing simulations and games that furnish an immersive race participation experience for virtual drivers and spectators.

The ability to simulate behavior of the various components; Horse, Vehicle, Harness and Driver and the group as a whole makes it possible to adjust training and driving and configuration to determine the safest conditions and to achieve the greatest competitive advantage.

The ability to simulate behavior of the various components; Horse, Vehicle, Harness and Driver and the group as a whole makes it possible to predict likely outcome and inform an immersive race participation gaming experience for remote participants or spectators or for training of young drivers and trainers.

The ability to inform simulation of immersive race participation gaming experience would allow for gambling on predefined milestones or on the outcome of actual races versus race simulation or fantasy racing.

### Competitive Simulations

Expanding upon the simulation concept disclosed above, participants can emulate drivers by sitting in a chariot of the type shown in FIG. 11 or by sitting in front of an interactive computer, game console, arcade console, or television set. The computer or television screen would duplicate an actual race or simulate a race in the same manner as is shown on the screen of FIG. 11. Each person who either sits in a chariot or in front of a computer or television screen is a game player. A mobile device can also be used instead. The Wii or Xbox platform would be ideal for this application. A slot machine can also be adapted to this application. A plurality of players can be linked to one another electronically via hard wire, wireless communication, cloud computing, Bluetooth, the Internet, or any other means of electronic communication. Each player is a virtual driver in a simulated race. When there are a large number of players, several races can run simultaneously, and the winners of each race get to compete in further races tournament style. Eventually, there can be quarter-finals, semi-finals, finals, or on a local, regional, national, or international basis, etc. The fantasy game could include provisions for wagering.

Based upon the telemetry received from horse, driver, and chariot, a computer can be programmed with predictive analytics. Artificial intelligence can be used to evaluate the results of actions taken or not taken by players. Thus, the computer can predict which horse will win the race. Also, a computer can determine which team was the safest or most efficient in crossing the finish line or predetermined milestones. Therefore, “winning” can be redefined as not only crossing the wire first but as which player was safest and most efficient in doing so. Regarding the gambling aspects of the Present Invention, we are dealing here with a game of player skill and not a game of chance. The player makes informed decisions to affect the outcome of a race.

Simulations can be done for training, exhibition races, actual horse races and for computer generated horse races. In both cases, the players use telemetry data received from sensors situated on the horse, the driver, and the chariot, as shown in FIGS. 4, 5, and 6. Players train in the same manner as drivers that use the simulator. The players then interact with the racing scenario. For example, at some point in the race, it may be desired to apply additional torque to the chariot wheels to slow the horse down, followed by less torque to cause the horse to run faster. Parameters may need to be adjusted based upon the horse's heart rate and lactic acid levels. Players and drivers can do many things in reaction to telemetry received in the simulator.

If a player is participating in an actual horse race, that player can be designated to be a virtual driver of a real horse. Based upon the telemetry, the player may take actions that are different than those taken by the actual driver. Thus, the player's horse may finish the race in a different position than the real horse. The player's horse may win the race, while the same real horse might lose (or vice versa). Thus the virtual driver can compare his results with those of the real driver. The game and the race are both run in real time. Once again, this game lends itself to wagering.

Although this specification teaches the utility of the Present Invention for the harness racing industry, it also has utility for flat racing and jump racing where a cart is not pulled by a horse. Here, the sensors are affixed to the jockey and the horse or on the saddle, but the type of display remains the same. Furthermore, the Present Invention has utility in races by animals other than horses.

I claim:

1. A system for sending and receiving synchronized performance information from an individual animal in a race comprised of a plurality of animals and a human who controls the individual animal, wherein the race is conducted in a location comprising surroundings and environment, said system comprising:
a) at least one sensor affixed to the individual animal;
b) at least one sensor affixed to the human;
c) an electronics package to process data from the at least one sensor affixed to the individual animal and to the human;
d) a transmitter that transmits data from the at least one sensor affixed to the individual animal and to the human;
e) a receiver that receives the data; and
f) a display device that displays the received data.

2. The system of claim 1 wherein the data is in an audio, video, or digital data format.

3. The system of claim 1 wherein the data is broadcast wirelessly.

4. The system of claim 1 wherein the display is contained in a Wii, Xbox, smart phone, or computer gaming platform.

5. The system of claim 1 wherein the at least one sensor monitors heart rate, blood pressure, recovery time or lactic acid level of the individual animal.

6. The system of claim 1 wherein the at least one sensor affixed to the individual animal is one of a plurality of sensors affixed to the individual animal.

7. The system of claim 6 wherein one of the plurality of sensors affixed to the individual animal is a video camera that is able to wirelessly transmit sequential video to the display device, wherein said display device is able to display the sequential video.

8. The system of claim 1 wherein the at least one sensor affixed to the human is one of a plurality of sensors affixed to the human.

9. The system of claim 8 wherein one of the plurality of sensors affixed to the human is a video camera that is able to wirelessly transmit sequential video to the display device, wherein said display device is able to display sequential video.

10. The system of claim 1 further comprising at least one additional sensor that monitors the surroundings and environment of the race location, wherein data from the at least one additional sensor is transmitted by the transmitter to the receiver and is displayed on the display device.

11. The system of claim 10 wherein the at least one additional sensor is one of a plurality of additional sensors that monitors the surroundings and environment of the race location.

12. The system of claim 1 wherein the race comprises real animals and a real human, and wherein the data is transmitted and received in real time during the race.

13. The system of claim 1 wherein the individual animal is a horse.

14. The system of claim 1 wherein the display device displays the received data to the human.

15. The system of claim 1 wherein the display device displays the received data to a spectator.

16. The system of claim 15 further comprising a transmitting and receiving device that allows the spectator to communicate with the human.

17. The system of claim 15 further comprising a computer, wherein:
a) the individual animal is one that is electronically simulated by computer software;
b) the at least one sensor affixed to the individual animal is electronically simulated by computer software.

18. The system of claim 1 further comprising a vehicle that is occupied by the human, wherein the vehicle is drawn by the individual animal during the race.

19. The system of claim 18 further comprising at least one sensor affixed to the vehicle, wherein data from the at least one sensor affixed to the vehicle is transmitted by the transmitter to the receiver and is displayed on the display device.

20. The system of claim 19 wherein the at least one sensor affixed to the vehicle is one of a plurality of sensors affixed to the vehicle.

21. The system of claim 20 wherein one of the plurality of sensors affixed to the vehicle is a video camera that is able to wirelessly transmit sequential video to the display device, wherein said display device is able to display sequential video.

22. The system of claim 18 wherein the display device is affixed to the vehicle.

23. The system of claim 18 wherein the vehicle further comprises a computer.

24. The system of claim 23 wherein the computer comprises input and output devices that permit the human to interact with the computer.

25. The system of claim 24 wherein the computer further comprises a central processing unit, and input/output connections.

26. The system of claim 24 wherein the input and output devices are selected from the group consisting of a keyboard, a mouse, a joystick, and a trigger.

27. The system of claim 18 wherein the vehicle further comprises a generator in some form to produce and supply electrical energy in transit to onboard systems or for other systems remote from the vehicle.

28. The system of claim 18 wherein the vehicle further comprises a redundant braking system that increases or decreases resistance to the motion of the vehicle.

29. The system of claim 18 further comprising a computer, wherein:
a) the individual animal is one that is electronically simulated by computer software;
b) the at least one sensor affixed to the individual animal is electronically simulated by computer software; and
c) the display device displays the received data to a spectator.

30. The system of claim 18 wherein the data is broadcast wirelessly.

31. The system of claim 18 wherein the vehicle further comprises a battery and power management electronics.

32. The system of claim 15 wherein the display device that is viewed by the spectator is one of a plurality of display devices that are viewed simultaneously by a plurality of spectators.

33. The system of claim 32 where the plurality of display devices are connected to a plurality of computers that allow input from the plurality of spectators.

34. The system of claim 33 wherein the plurality of computers are integrated together as a network.

35. The system of claim 33 wherein any spectator from the plurality of spectators is a participant that provides input to the computer.

36. The system of claim 34 wherein the type of network is a local area network, a wide area network, the Internet, or the Cloud.

37. The system of claim 34 wherein each of the plurality of computers contains analytic software that can predict the outcome of the race.

38. The system of claim 34 wherein the analytic software allows the plurality of spectators to input virtual advice to control the vehicle and individual animal, wherein the spectator can act as a simulated human to produce a simulated race and compare the results of the spectators simulated race to that of the race run by the human controlling the individual animal.

39. The system of claim 37 wherein the analytic software can predict when milestones are achieved.

40. The system of claim 37 wherein the analytic software can predict whether the individual animal will win the race.

41. The system of claim 37 wherein the analytic software can predict the order in which the individual animal will finish the race compared to the plurality of animals in the race.

42. The system of claim 37 wherein the analytic software can predict accidents or injury to the human or individual animal.

43. The system of claim 37 wherein the analytic software can evaluate the results of actions taken or not taken by spectators.

44. The system of claim 39 wherein the computer comprises input and output devices that permit the spectator to interact with the computer, thus simulating control of the vehicle and simulated individual animal by the spectator.

45. The system of claim 44 wherein the computer further comprises a central processing unit, and input/output connections.

46. The system of claim 44 wherein the input and output devices are selected from the group consisting of a keyboard, a mouse, a joystick, a trigger, and a voice activated device.

47. The system of claim 46 wherein:
a) the vehicle is a simulation; and
b) the display device that is viewed by the spectator is one of a plurality of display devices that are viewed simultaneously by a plurality of spectators.

48. The system of claim 46 where the plurality of display devices are connected to a plurality of computers that allow input from the plurality of spectators.

49. The system of claim 48 wherein the plurality of computers are integrated together as a network.

50. The system of claim 49 wherein the type of network is a local area network, a wide area network, the Internet, or the Cloud.

51. The system of claim 50 wherein each of the plurality of computers contains analytic software that can predict the outcome of the race.

52. The system of claim 51 wherein the analytic software can predict when milestones are achieved.

53. The system of claim 52 wherein the analytic software can predict whether the individual animal will win the race or whether the predicted milestones will be achieved.

54. The system of claim 51 wherein the analytic software can predict the order in which the individual animal will finish the race compared to the plurality of animals in the race.

55. The system of claim 51 in wherein the analytic software allows the a spectator included in the plurality of spectators compete against other spectators included in the plurality of spectators.

56. The system of claim 55 wherein the race is simulated.

57. The system of claim 43 wherein the analytic software can rate safety and efficiency of actions taken or not taken by spectators.

58. The system of claim 52 wherein the analytic software can predict the order in which the individual animal will achieve the predicted milestones compared to the plurality of animals in the race.

59. The system of claim 1 wherein the individual animal is controlled by a plurality of drivers.

60. The system of claim 1 wherein the at least one sensor monitors heart rate, blood pressure, recovery time or lactic acid level of the human.
